(19) United States
(12) Patent Application Publication
(10) Pub. No.: US 2026/0330369 A1
(43) Pub. Date: Oct. 22, 2026

(54) GENERATING FRICTION IN PAYMENT WORKFLOWS FOR A USER

(71) Applicant: International Business Machines Corporation, Armonk, NY (US)

(72) Inventors: Thomas James Waterton, Southampton (GB); Paritosh Ranjan, Kolkata (IN); Marc P. Yvon, Antony (FR)

(21) Appl. No.: 19/185,436

(22) Filed: Apr. 22, 2025

(51) Int. Cl. G06Q 10/0633; G06Q 20/40; G06Q 30/0601

(52) U.S. Cl. CPC G06Q 10/0633; G06Q 20/4016; G06Q 30/0643

(57) ABSTRACT

A computer-implemented method is provided. A processor set receives a request from a user to complete a transaction to purchase a number of items through a graphical user interface. The processor set generates a number of visual representations for the number of items on the graphical user interface. The number of visual representations represent monetary values for the number of items. The process set generates a number of obstacles associated with the number of visual representations on the graphical user interface for the user to complete the transaction. The number of obstacles associated with the number of visual representations on the graphical user interface causes delay for the transaction to complete. If the processor set receives a number of user inputs from the user to resolve the number of obstacles, then the processor set completes the transaction to purchase the number of items for the user.

### BACKGROUND

The disclosure relates generally to generating friction in payment workflows for a user.

A payment workflow is a structured sequence of steps that facilitate the transfer of funds between a payer and a recipient in a secure and efficient manner. It involves multiple stages that include payment initiation, authorization, processing, and settlement. The workflow begins when a payer initiates a transaction through a payment method, and then payment details are transmitted to a payment gateway, which validates the transaction and forwards it to a payment processor or financial institution for approval.

In this illustrative example, payment workflows can vary based on the type of transaction, whether it is an online purchase, subscription billing, invoice payment, or peer-to-peer transfer. Businesses often integrate payment workflows with accounting systems and customer management platforms to track payments, generate receipts, and manage refunds or disputes. A well-optimized payment workflow ensures seamless, fast, and secure transactions while providing a smooth experience for both the payer and the recipient.

### SUMMARY

According to one illustrative embodiment, a computer-implemented method is provided. A processor set receives a request from a user to complete a transaction to purchase a number of items through a graphical user interface. The processor set generates a number of visual representations for the number of items on the graphical user interface. The number of visual representations represent monetary values for the number of items. The process set generates a number of obstacles associated with the number of visual representations on the graphical user interface for the user to complete the transaction. The number of obstacles associated with the number of visual representations on the graphical user interface causes delay for the transaction to complete. The processor set receives a number of user inputs from the user to resolve the number of obstacles. The processor set completes the transaction to purchase the number of items for the user. According to other illustrative embodiments, a computer system and a computer program product are also provided.

### BRIEF DESCRIPTION OF THE DRAWINGS

FIG. 1 is a pictorial representation of a computing environment in which illustrative embodiments may be implemented;

FIG. 2 is an illustration of a block diagram of a transaction management environment in accordance with an illustrative embodiment;

FIG. 3 is an illustration of displays of visual representations for introducing obstacles to users for completing transactions in accordance with an illustrative embodiment;

FIG. 4 is an illustration of displays of visual representations for introducing obstacles to users for completing transactions in accordance with an illustrative embodiment;

FIG. 5 is an illustration of displays of visual representations for introducing obstacles to users for completing transactions in accordance with an illustrative embodiment;

FIG. 6 is an illustration of a process for managing a transaction for a user in accordance with an illustrative embodiment;

FIG. 7 is an illustration of a process for storing data associated with transactions in accordance with an illustrative embodiment;

FIG. 8 is an illustration of a process for creating a profile for a user based on spending pattern of the user in accordance with an illustrative embodiment;

FIG. 9 is an illustration of a process for determining a risk score for a transaction in accordance with an illustrative embodiment;

FIG. 10 is an illustration of a process for blocking transactions in accordance with an illustrative embodiment; and

FIG. 11 is a block diagram of a data processing system in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one or more storage media (also called “mediums”) collectively included in a set of one or more storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

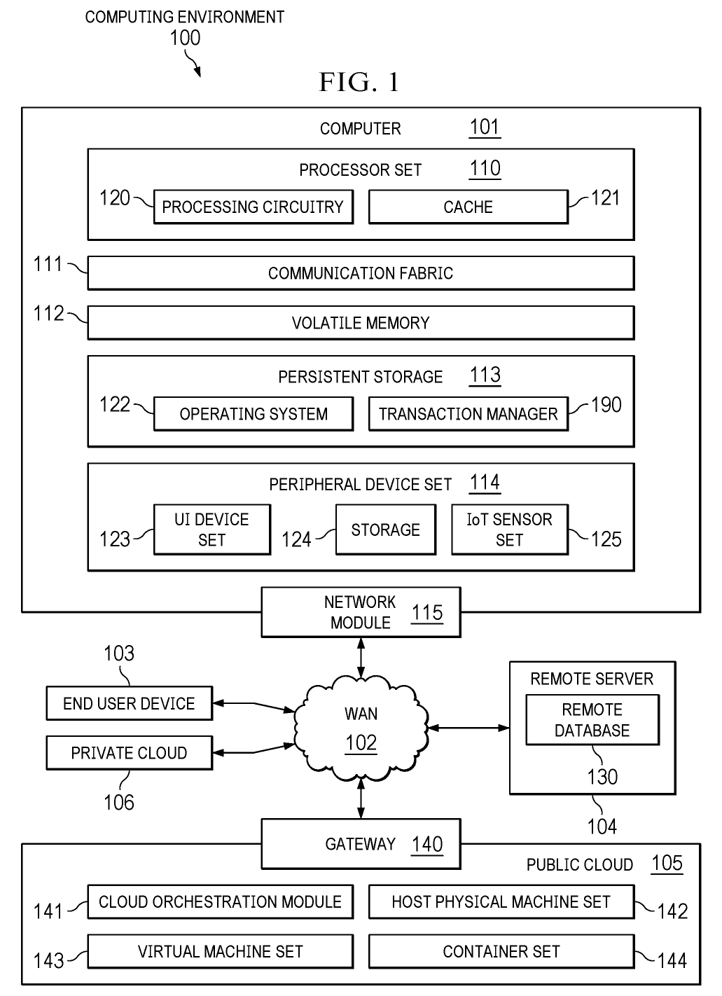

With reference now to the figures, and in particular with reference to FIG. 1, a block diagram of a computing environment is depicted in accordance with an illustrative embodiment. Computing environment 100 contains an example of an environment for the execution of at least some of the computer code involved in performing the inventive methods, such as transaction manager 190. In addition to transaction manager 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and transaction manager 190, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one or more computer processors of any type now known or to be developed in the future. Processing circuitry 120 may be distributed over multiple packages, for example, multiple coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions and associated data are accessed by processor set 110 to control and direct performance of the inventive methods. In computing environment 100, at least some of the instructions for performing the inventive methods may be stored in transaction manager 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, volatile memory 112 is located in a single package and is internal to computer 101, but, alternatively or additionally, volatile memory 112 may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in transaction manager 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as a thin client, heavy client, mainframe computer, desktop computer, and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data application portability between the multiple constituent clouds. In this embodiment, public cloud 105 and private cloud 106 are both part of a larger hybrid cloud.

CLOUD COMPUTING SERVICES AND/OR MICROSERVICES: Public cloud 105 and private cloud 106 are programmed and configured to deliver cloud computing services and/or microservices (not separately shown in FIG. 1). Unless otherwise indicated, the word “microservices” shall be interpreted as inclusive of larger “services” regardless of size. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to an “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The illustrative embodiments recognize and take into account one or more different considerations as described herein. For example, the illustrative embodiments recognize and take into account that potentially large sums of money are represented as mere digits on users’ devices when users make purchases using those devices. The illustrative embodiments recognize and take into account that making purchases using digital devices are too quick and too convenient, which makes it too easy for people to spend money without necessarily thinking through their actions sufficiently.

The illustrative embodiments recognize and take into account that current technology for making purchases on digital devices lead to impulse buying, overspending, over-valuation of items, and ultimately results in debt and financial problems.

The illustrative embodiments also recognize and take into account that different users value money differently based on many factors including their culture, background, income amount, and income source. For example, a poultry farmer might visualize a sum of money in terms of the number of chickens he raised while a daily wage worker might visualize money in terms of the number of days’ worth of wages.

Thus, illustrative embodiments of the present invention provide a computer implemented method, computer system, and computer program product. A processor set receives a request from a user to complete a transaction to purchase a number of items through a graphical user interface. The processor set generates a number of visual representations for the number of items on the graphical user interface. The number of visual representations represent monetary values for the number of items. The process set generates a number of obstacles associated with the number of visual representations on the graphical user interface for the user to complete the transaction. The number of obstacles associated with the number of visual representations on the graphical user interface causes delay for the transaction to complete. The processor set receives a number of user inputs from the user to resolve the number of obstacles. The processor set completes the transaction to purchase the number of items for the user.

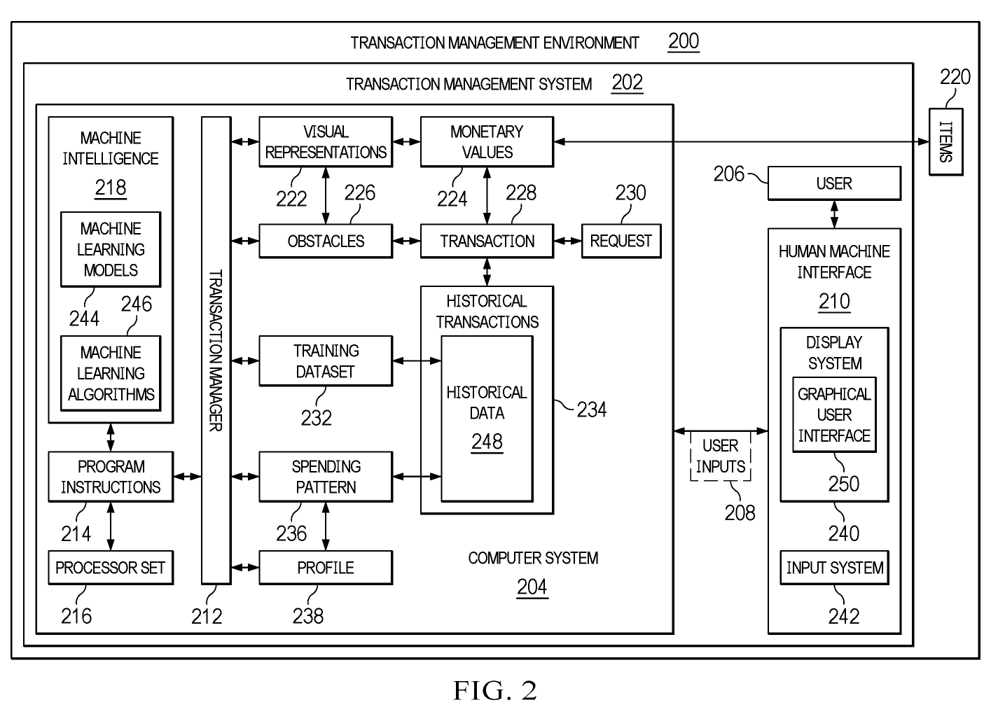

With reference now to FIG. 2, an illustration of a block diagram of a transaction management environment is depicted in accordance with an illustrative embodiment. In this illustrative example, transaction management environment 200 includes components that can be implemented in hardware such as the hardware shown in computing environment 100 in FIG. 1.

In this illustrative example, transaction management system 202 in transaction management environment 200 can be used to generate obstacles 226 for delaying completion of transaction 228 for user 206. In this illustrative example, obstacles 226 can also be referred as “friction” in a transaction, which causes delay or inefficiency that makes the payment or purchasing process slower, more complex, or inconvenient for the user. In this illustrative example, obstacles 226 are required to be resolved in order for transaction manager 212 to complete transaction 228. Such mechanism delays the completion of transaction 228 and thereby providing more time for user 206 to evaluate transaction 228 as user 206 resolves obstacles 226. As a result, impulse buying, overpayment, and fraud transactions can be efficiently avoided.

In this illustrative example, transaction management system 202 includes computer system 204 which includes transaction manager 212. Transaction manager 212 is located in computer system 204. Transaction manager 212 may be implemented using transaction manager 190 in FIG. 1. In this illustrative example, transaction manager 212 can receive request 230 from user 206 to complete transaction 228 for purchasing a number of items 220.

Transaction manager 212 can be implemented in software, hardware, firmware, or a combination thereof. When software is used, the operations performed by transaction manager 212 can be implemented in program instructions configured to run on hardware, such as a processor unit. When firmware is used, the operations performed by transaction manager 212 can be implemented in program instructions and data and stored in persistent memory to run on a processor unit. When hardware is employed, the hardware can include circuits that operate to perform the operations in transaction manager 212.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “a number of” when used with reference to items, means one or more items. For example, “a number of operations” is one or more operations.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C,” may include item A, item A and item B, or item B. This example also may include item A, item B, and item C, or item B and item C. Of course, any combination of these items can be present. In some illustrative examples, “at least one of” can be, for example, without limitation, two of item A; one of item B; and ten of item C; four of item B and seven of item C; or other suitable combinations.

Computer system 204 is a physical hardware system and includes one or more data processing systems. When more than one data processing system is present in computer system 204, those data processing systems are in communication with each other using a communications medium. The communications medium can be a network. The data processing systems can be selected from at least one of a computer, a server computer, a tablet computer, or some other suitable data processing system.

As depicted, computer system 204 includes processor set 216 that is capable of executing program instructions 214 implementing processes in the illustrative examples. In other words, program instructions 214 are computer-readable program instructions.

As used herein, a processor unit in processor set 216 is a hardware device and is comprised of hardware circuits such as those on an integrated circuit that respond to and process instructions and program code that operate a computer. A processor unit can be implemented using processor set 110 in FIG. 1. When processor set 216 executes program instructions 214 for a process, processor set 216 can be one or more processor units that are in the same computer or in different computers. In other words, the process can be distributed between processor set 216 on the same or different computers in computer system 204.

Further, processor set 216 can be of the same type or different types of processor units. For example, processor set 216 can be selected from at least one of a single core processor, a dual-core processor, a multi-processor core, a general-purpose central processing unit (CPU), a graphics processing unit (GPU), a digital signal processor (DSP), or some other type of processor unit.

As depicted, computer system 204 includes machine intelligence 218. Machine intelligence 218 can include machine learning models 244 and machine learning algorithms 246. Machine learning models 244 is a branch of artificial intelligence (AI) that enables computers to detect patterns and improve performance without direct programming commands. Rather than relying on direct input commands to complete a task, machine learning models 244 relies on input data. The data is fed into the machine, one of machine learning algorithms 246 is selected, parameters for the data are configured, and the machine is instructed to find patterns in the input data through optimization algorithms. The data model formed from analyzing the data is then used to predict future values.

Machine intelligence 218 is continuously refined over time through trial and error. Equivalence of assets or products can be effectively performed by supervised machine learning so that products or assets that do not match descriptively can nevertheless be matched. Over time, the data model from machine learning can provide a greater degree of flexibility in matching machine intelligence 218.

Machine intelligence 218 can be implemented using one or more systems such as an artificial intelligence system, a neural network, a generative neural network, a Bayesian network, an expert system, a fuzzy logic system, a genetic algorithm, or other suitable types of systems. In this illustrative example, machine learning models 244 can include a number of large language models that are designed to understand, generate, and process human language. Machine learning models 244 and machine learning algorithms 246 may make computer system 204 a special purpose computer for generating obstacles 226 for transaction 228.

Machine learning models 244 involves using machine learning algorithms 246 to build computation models based on samples of data. The samples of data used for training are referred to as training data or training datasets. Machine intelligence 218 can make predictions without being explicitly programmed to make these predictions. Machine intelligence 218 can be used for training and retraining computation models for a number of different types of applications. These applications include, for example, medicine, financial services, healthcare, speech recognition, computer vision, or other types of applications.

In this illustrative example, machine learning algorithms 246 can include supervised machine learning algorithms and unsupervised machine learning algorithms. Supervised machine learning can train machine learning models using data containing both the inputs and desired outputs. Examples of machine learning algorithms include XGBoost, K-means clustering, and random forest. In addition, machine learning algorithms 246 can also include semi-supervised learning which necessitates human involvement for input validations.

As depicted, transaction manager 212 can generate obstacles 226 for transaction 228. In this example, transaction manager 212 can generate obstacles 226 for transaction 228 in a number of ways. For example, transaction manager 212 can generate a number of visual representations 222 to represent monetary values 224 for the number of items 220. In this example, monetary values 224 are price or financial worth assigned to the number of items 220. In other words, monetary values 224 is the cost for user 206 to complete transaction 228 for purchasing the number of items 220. In this illustrative example, if the total purchase amount cannot be constructed solely using amounts represented by visual representations 222, any remainder is shown as numerical cash values.

In this illustrative example, interactions between user 206 and visual representations 222 can be created for resolving obstacles 226. For example, transaction manager 212 can require user 206 to drag visual representations 222 to a destinated area in graphical user interface 250 of display system 240 for resolving obstacles 226.

In this illustrative example, user 206 can interact with computer system 204 via user inputs 208. User inputs 208 can be generated by user 206 using human machine interface (HMI) 210. For example, user 206 can interact with obstacles 226 through user inputs 208. As depicted, human machine interface 210 includes display system 240 and input system 242. Display system 240 is a physical hardware system and includes one or more display devices on which graphical user interface 250 can be displayed. The display devices can include at least one of a light emitting diode (LED) display, an organic light emitting diode (OLED) display, a computer monitor, a projector, a flat panel display, a heads-up display (HUD), a head-mounted display (HMD), smart glasses, augmented reality glasses, virtual reality headsets, or some other suitable device that can output information for the visual presentation of information.

As depicted, user 206 is a person that can interact with graphical user interface 250 through user inputs 208 generated by input system 242. Input system 242 is a physical hardware system and can be selected from at least one of a mouse, a keyboard, a touch pad, a trackball, a touchscreen, a stylus, a motion sensing input device, a gesture detection device, a data glove, a cyber glove, a haptic feedback device, or some other suitable type of input device. In this illustrative example, user 206 can view visual representations 222 through graphical user interface 250.

As a result, transaction manager 212 completes transaction 228 for user 206 to purchase the number of items 220 after obstacles 226 are resolved. In this illustrative example, transaction manager 212 stores information associated with the number of items 220, monetary values 224, duration for completing transaction 228, visual representations 222, and obstacles 226 as part of historical data 248 for historical transactions 234. In this illustrative example, historical transactions 234 include data associated with all transactions completed by user 206.

In this illustrative example, transaction manager 212 can use historical data 248 to form training dataset 232 to train machine learning models 244. In this example, machine learning models 244 are trained for generating visual representations such as visual representations 222 that minimizes understanding gaps such that visual representations 222 can be helpful to ensure that user 206 fully appreciates monetary values that represent the amount of money associated with completing a transaction such as transaction 228. For example, instead of just seeing an abstract figure such as “$999” in a standard UI purchase process, user 206 sees a visual representation that is more meaningful to user 206. In other words, minimizing understanding gaps can lead to an increase of appreciation for user 206 of the transaction cost value.

In this illustrative example, transaction manager 212 can use machine learning models 244 to identify spending pattern 236 for user 206 based on historical data 248 associated with historical transactions 234. In this illustrative example, spending pattern 236 is a representation of recurring habits and behaviors that user 206 exhibits when making purchases or financial transactions. In this example, data that are associated with spending pattern 236 can include items purchased, unit price, quantity purchased, source of purchase, day and time of purchase, whether a unique or repeat purchase, inferred emotional state of user 206 at the time of purchase determined based on factors such as day and time of purchase, local weather conditions at time of purchase, calendar events preceding the purchase, and direct feedback assessments provided by user 206 for recent purchases.

In this illustrative example, transaction manager 212 can use machine learning models 244 to generate profile 238 for user 206. In this example, profile 238 can be a spending profile that represents patterns and trends of spending for user 206.

In this illustrative example, transaction manager 212 can further use machine learning models 244 and profile 238 to detect risk associated transactions. For example, transaction manager 212 can receive a second request from user 206 to complete a second transaction through graphical user interface 250. In this example, transaction manager 212 can use machine learning models 244 to analyze information associated with the second transaction to determine a risk score for the second transaction.

For example, if the second transaction involves purchasing a low-cost item that user 206 had bought previously from the same supplier, the calculated risk score would be low. In such circumstances, transaction manager 212 can be configured to not inject any additional steps on top of the vendor’s default purchasing process.

On the other hand, if the second transaction involves purchasing an expensive item that user 206 has not bought previously from a vendor user 206 has not used before, and when the attempted purchase is late on a Friday night, the calculated risk score would be very high. In such circumstances, transaction manager 212 can be configured to inject additional steps on top of the vendor’s default (as-is) purchasing process such as generating obstacles 226 for user 206 to resolve as mentioned above. In an alternative illustrative example, transaction manager 212 can also be configured to block the second transaction for user 206 if the risk score determined for the second transaction exceeds a pre-defined threshold.

In this illustrative example, machine learning models 244 can also be used for generating visual representations such as visual representations 222 for user 206 based on profile 238. In this example, machine learning models 244 can generate visual representations that have particular meaning and value to user 206. These could be images of banknotes, images representing days’ wages, images of livestock, images of Christmas presents, or any suitable visual representations. In an alternative illustrative example, user 206 can manually choose what visual representations user 206 wants for completing transactions.

In addition, machine learning models 244 can receive feedback from user 206 to rate how satisfied or regretful user 206 feels about previous transactions and this feedback can be used for machine learning models 244 to determine whether or not the tool would apply friction or obstacles to similar transactions in the future. In other words, machine learning models 244 can dynamically determine whether incoming transactions are low risk transactions or high risk transactions for user 206 and apply friction or obstacles accordingly.

Further, machine learning models 244 can also be used to optimize workloads for computer system 204. In this illustrative example, a large influx of requests for completing transactions can result in huge overhead for computer system 204. In this example, machine learning models 244 can dynamically generate obstacles or friction to delay the process of low priority requests and allocate more computational resources to high priority requests at the same time. As a result, computational resources can be efficiently allocated to computer system 204 for increasing performance and efficiency of computer system 204.

In one illustrative example, one or more solutions are present that overcome a problem with system overheads, overspending, impulse buying, and fraud detection. As a result, one or more technical solutions may provide an ability to increase the efficiency for fraud detection and workload optimization. In the illustrative example, computer system 204 can be configured to perform at least one of the steps, operations, or actions described in the different illustrative examples using software, hardware, firmware, or a combination thereof. As a result, computer system 204 operates as a special purpose computer system in which transaction manager 212 in computer system 204 enables delaying of transaction completion to avoid system overheads, overspending, impulse buying, and fraud transaction. In particular, transaction manager 212 transforms computer system 204 into a special purpose computer system as compared to currently available general computer systems that do not have transaction manager 212.

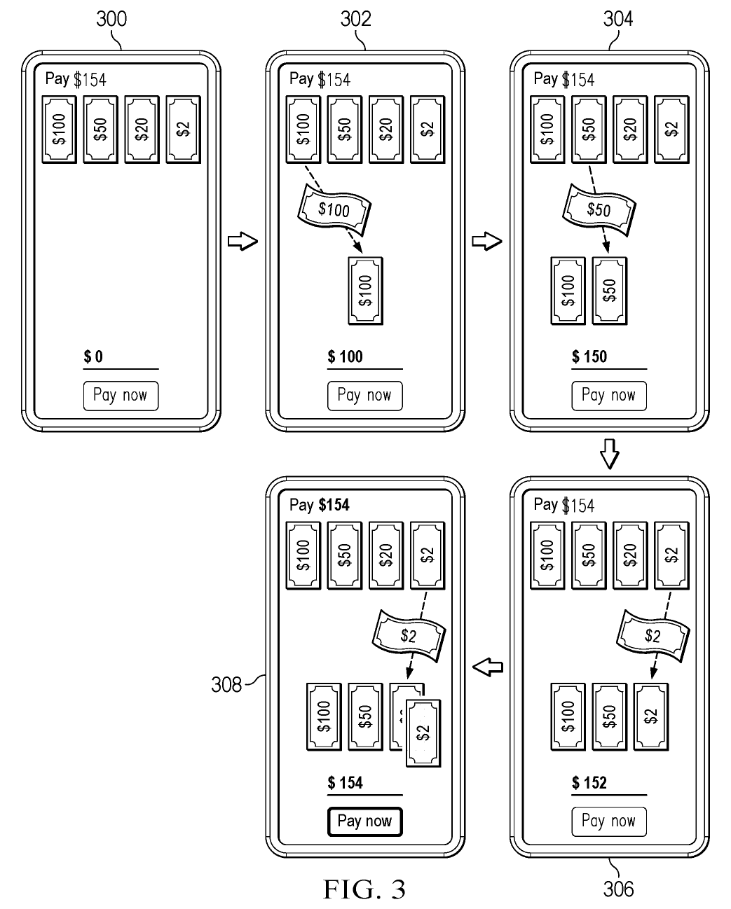

With reference now to FIG. 3, a diagram illustrating displays of visual representations for introducing obstacles to users for completing transactions is shown in accordance with an illustrative embodiment. In this illustrative example, display 300, display 302, display 304, display 306, and display 308 can be examples of displays presented in graphical user interface 250 in FIG. 2. In addition, visual representations shown on display 300, display 302, display 304, display 306, and display 308 can be examples of visual representations 222 in FIG. 2. In this illustrative example, the visual representations in FIG. 3 can be generated based on user preference determined using machine learning models 244 in FIG. 2.

In this illustrative example, displays in FIG. 3 shows a generation of obstacles for a user to complete a transaction. As depicted, obstacles can also be referred as “friction” in a transaction, which causes delay or inefficiency that makes the payment or purchasing process slower, more complex, or inconvenient for the user. In this illustrative example, friction is generated using haptics of graphical user interface of a mobile device, where the user is required to drag visual representations on the graphical user interface to destinated locations for resolving the friction or obstacles.

In display 300, a number of visual representations are made to represent the monetary values of the items to be purchased by the user. In this example, a combination of United States dollar bills are used as visual representations to represent a purchase price of one hundred and fifty-four dollars for the items to be purchased. In this illustrative example, the user must drag and drop the appropriate visual representations that total one hundred and fifty-four dollars in order to complete the transaction.

In display 302, the visual representation of a one hundred dollar bill is dragged to the bottom of the graphical user interface to represent that the user is aware that the transaction of the item to be purchased requires at least one hundred dollars, and the user is willing to pay the amount for the items to be purchased. As a result, the total amount at the bottom of the graphical user interface is changed from “0” to “100.”

In a similar fashion, in display 304, the visual representation of a fifty dollar bill is dragged to the bottom of the graphical user interface to represent that the user is aware that the transaction of the item to be purchased requires at least one hundred and fifty dollars, and the user is willing to pay the amount for the items to be purchased. As a result, the total amount at the bottom of the graphical user interface is changed from “100” to “150.”

In addition, in display 306, the visual representation of one dollar bill is dragged two times to the bottom of the graphical user interface to represent that the user is aware that the transaction of the item to be purchased requires at least one hundred and fifty-two dollars, and the user is willing to pay the amount for the items to be purchased. As a result, the total amount at the bottom of the graphical user interface is changed from “150” to “152.”

Subsequently in display 308, the visual representation of one dollar bill is dragged two times to the bottom of the graphical user interface to represent that the user is aware that the transaction of item to be purchased requires at least one hundred and fifty-four dollars, and the user is willing to pay the amount for the items to be purchased. As a result, the total amount at the bottom of the graphical user interface is changed from “152” to “154.”

As a result, the friction or obstacles introduced to the user is resolved and the “pay now” button becomes interactive on the graphical user interface, as illustrated in display 308. In this illustrative example, the delay to the completion of transaction caused by the friction or obstacles creates time for the user to think and provide clear insights to the user of how much the user is spending for purchasing, which can be helpful to avoid impulse buying, overpayment, and fraud transactions.

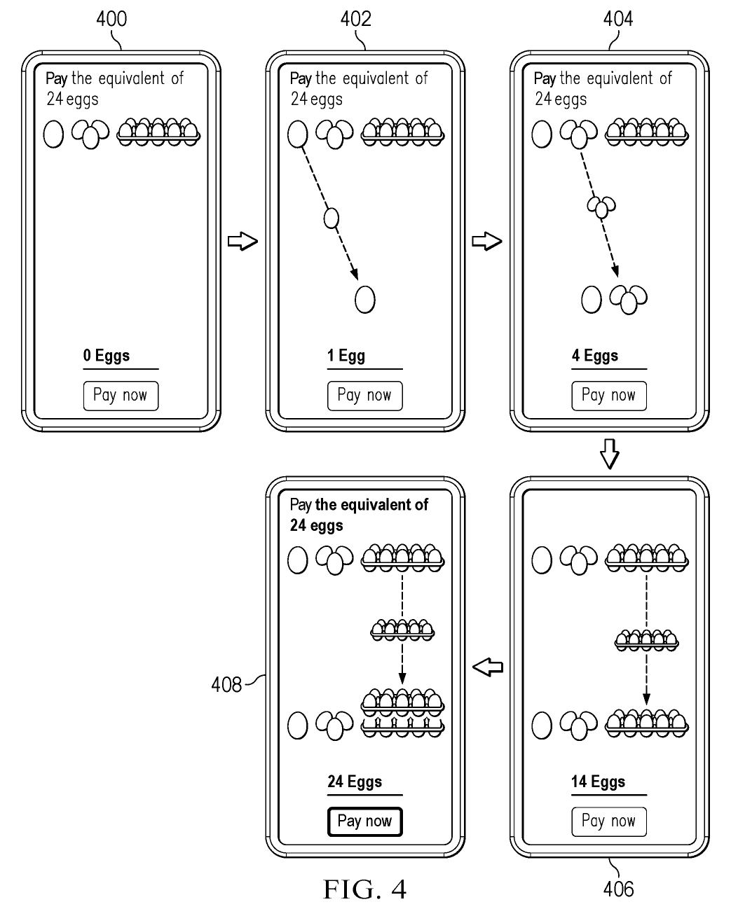

With reference now to FIG. 4, a diagram illustrating displays of visual representations for introducing obstacles to users for completing transactions is shown in accordance with an illustrative embodiment. In this illustrative example, display 400, display 402, display 404, display 406, and display 408 can be examples of displays presented in graphical user interface 250 in FIG. 2. In addition, visual representations shown on display 400, display 402, display 404, display 406, and display 408 can be examples of visual representations 222 in FIG. 2. In this illustrative example, the visual representations in FIG. 4 can be generated based on user preference determined using machine learning models 244 in FIG. 2.

In this illustrative example, displays in FIG. 4 shows a generation of obstacles for a user to complete a transaction. In FIG. 4, friction is also generated using haptics of graphical user interface of a mobile device, where the user is required to drag visual representations on the graphical user interface to destinated locations for resolving the friction or obstacles.

In display 400, a number of visual representations are made to represent the monetary values of the items to be purchased by the user. In this example, a combination of eggs are used as visual representations to represent the purchase price of items that has a purchase price equivalent to twenty-four eggs. In this illustrative example, the user must drag and drop the appropriate visual representations to make a total of 24 eggs in order to complete the transaction.

In display 402, the visual representation of one egg is dragged to the bottom of the graphical user interface to represent that the user is aware that the transaction of the item to be purchased requires the monetary value of at least one egg, and the user is willing to pay the amount for the items to be purchased. As a result, the total amount at the bottom of the graphical user interface is changed from “0 egg” to “1 egg.”

In a similar fashion, in display 404, the visual representation of three eggs is dragged to the bottom of the graphical user interface to represent that the user is aware that the transaction of the item to be purchased requires the monetary value of at least four eggs, and the user is willing to pay the amount for the items to be purchased. As a result, the total amount at the bottom of the graphical user interface is changed from “1 egg” to “4 eggs.”

In addition, in display 406, the visual representation of ten eggs is dragged to the bottom of the graphical user interface to represent that the user is aware that the transaction of the item to be purchased requires the monetary value of at least fourteen eggs, and the user is willing to pay the amount for the items to be purchased. As a result, the total amount at the bottom of the graphical user interface is changed from “4 eggs” to “14 eggs.”

Subsequently in display 408, the visual representation of ten eggs is dragged once more to the bottom of the graphical user interface to represent that the user is aware that the transaction of the item to be purchased requires the monetary value of at least twenty-four eggs, and the user is willing to pay the amount for the items to be purchased. As a result, the total amount at the bottom of the graphical user interface is changed from “14 eggs” to “24 eggs.”

As a result, the friction or obstacles introduced to the user is resolved and the “pay now” button becomes interactive on the graphical user interface, as illustrated in display 408. The user can complete the transaction by pressing the “pay now” button illustrated in display 408.

In this illustrative example, the delay to the completion of the transaction caused by the friction or obstacles creates time for the user to think and provide clear insights to the user of how much the user is spending for purchasing, which can be helpful to avoid impulse buying, overpayment, and fraud transactions.

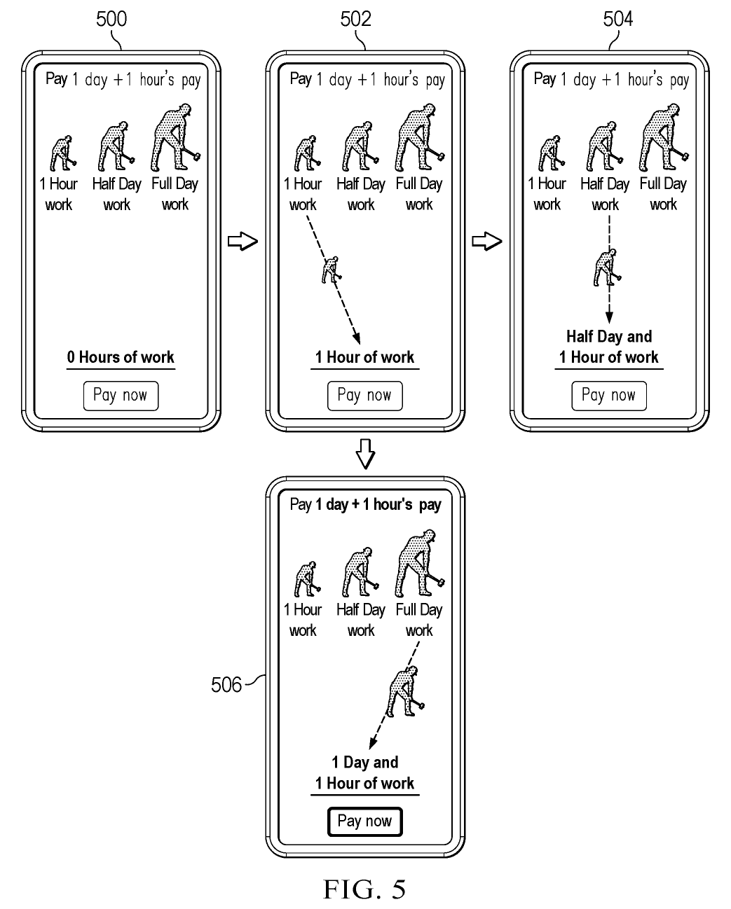

With reference now to FIG. 5, a diagram illustrating displays of visual representations for introducing obstacles to users for completing transactions is shown in accordance with an illustrative embodiment. In this illustrative example, display 500, display 502, display 504, and display 506 can be examples of displays presented in graphical user interface 250 in FIG. 2. In addition, visual representations shown on display 500, display 502, display 504, and display 506 can be examples of visual representations 222 in FIG. 2. In this illustrative example, the visual representations in FIG. 5 can be generated based on user preference determined using machine learning models 244 in FIG. 2.

In a similar fashion, displays in FIG. 5 shows a generation of obstacles for a user to complete a transaction. In FIG. 5, friction is also generated using haptics of a graphical user interface of a mobile device, where the user is required to drag visual representations on the graphical user interface to destinated locations for resolving the friction or obstacles.

In display 500, a number of visual representations are made to represent the monetary values of the items to be purchased by the user. In this example, graphics of a working person are used as visual representations to represent purchase price of items that have a purchase price equivalent to a pay that requires one day and one hour’s work for the user. In this illustrative example, the user must drag and drop the appropriate visual representations to make a total of one day and one hour’s worth of work pay for completing the transaction.

In display 502, the visual representation of a working person that represents a pay that requires one hour’s work for the user is dragged to the bottom of the graphical user interface to indicate that the user is aware that the transaction of the item to be purchased requires the monetary value of at least one hour’s work from the user, and the user is willing to pay the amount for the items to be purchased. As a result, the total amount at the bottom of the graphical user interface is changed from “0 hours of work” to “1 hour of work.”

In a similar fashion, in display 504, the visual representation of a working person that represents a pay that requires half day’s work for the user is dragged to the bottom of the graphical user interface to indicate that the user is aware that the transaction of the item to be purchased requires the monetary value of at least a half day and one hour’s work from the user, and the user is willing to pay the amount for the items to be purchased. As a result, the total amount at the bottom of the graphical user interface is changed from “1 hours of work” to “half day and 1 hour of work.”

In an alternative illustrative example, in display 506, instead of dragging the visual representation of a working person that represents a pay that requires half day’s work for the user, the visual representation of a working person that represents a pay that requires full day’s work for the user can be dragged to the bottom of the graphical user interface to indicate that the user is aware that the transaction of the item to be purchased requires the monetary value of at least one full day and one hour’s work from the user, and the user is willing to pay the amount for the items to be purchased. As a result, the total amount at the bottom of the graphical user interface is changed from “1 hours of work” to “1 day and 1 hour of work.”

As a result, the friction or obstacles introduced to the user is resolved and the “pay now” button becomes interactive on the graphical user interface, as illustrated in display 506. The user can complete the transaction by pressing “pay now” button illustrated in display 506.

In this illustrative example, the delay to the completion of the transaction caused by the friction or obstacles creates time for the user to think and provide clear insights to the user of how much the user is spending for purchasing, which can be helpful to avoid impulse buying, overpayment, and fraud transactions.

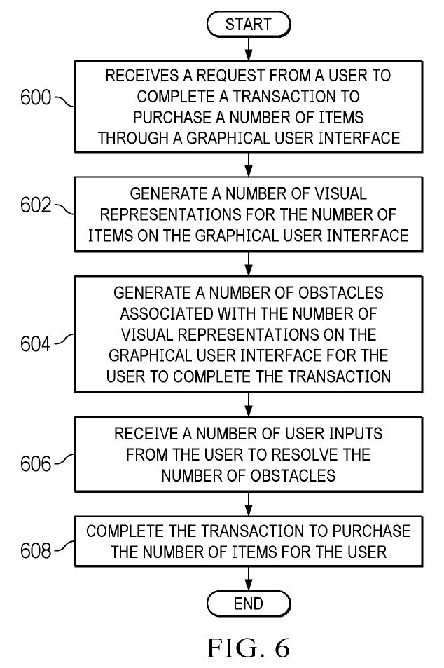

With reference now to FIG. 6, a flowchart illustrating a process for managing a transaction for a user is shown in accordance with an illustrative embodiment. The process in FIG. 6 can be implemented in hardware, software, or both. When implemented in software, the process can take the form of program instructions that are run by one of more processor units located in one or more hardware devices in one or more computer systems. For example, the process can be implemented in transaction manager 212 in computer system 204 in FIG. 2.

The process begins by receiving a request from a user to complete a transaction to purchase a number of items through a graphical user interface (step 600). The process generates a number of visual representations for the number of items on the graphical user interface (step 602). In this step, the number of visual representations represent monetary values for the number of items. The process generates a number of obstacles associated with the number of visual representations on the graphical user interface for the user to complete the transaction (step 604). In step 604, the number of obstacles associated with the number of visual representations on the graphical user interface causes delay for the transaction to complete. The process receives a number of user inputs from the user to resolve the number of obstacles (step 606). The process completes the transaction to purchase the number of items for the user (step 608). In this illustrative example, it should be understood that the completion of the transaction to purchase the number of items for the user is not necessarily the ending of the process. In an alternative illustrative example, the process exits the transaction without completing the transaction. The process terminates thereafter.

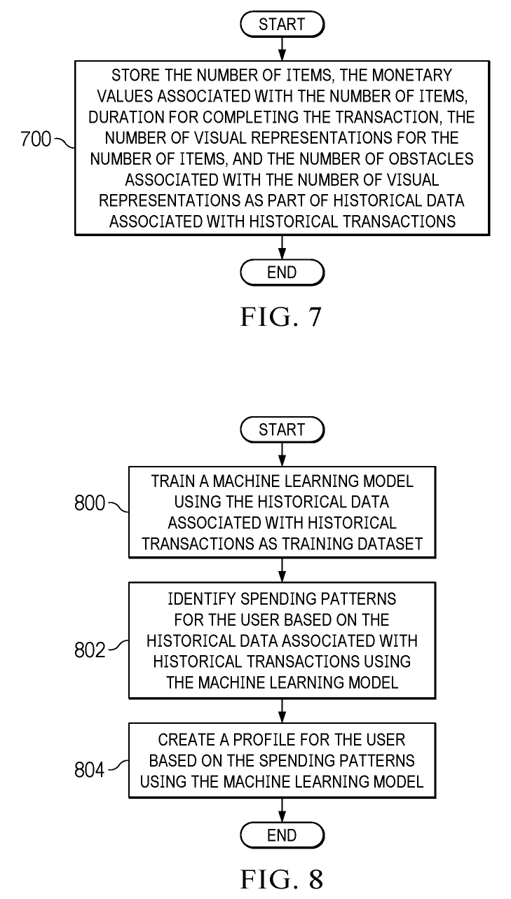

Turning next to FIG. 7, a flowchart of a process for storing data associated with transactions is depicted in accordance with an illustrative embodiment. The process in this figure is an example of an additional step that can be performed with the steps in FIG. 6.

The process begins by storing the number of items, the monetary values associated with the number of items, duration for completing the transaction, the number of visual representations for the number of items, and the number of obstacles associated with the number of visual representations as part of historical data associated with historical transactions (step 700). The process terminates thereafter.

Turning next to FIG. 8, a flowchart of a process for creating a profile for a user based on spending pattern of the user is depicted in accordance with an illustrative embodiment. The process in this figure is an example of an additional step that can be performed with the steps in FIG. 7.

The process begins by training a machine learning model using the historical data associated with historical transactions as training dataset (step 800). In this step, the machine learning model is trained for generating visual representations that minimizes understanding gaps. The process identifies spending patterns for the user based on the historical data associated with historical transactions using the machine learning model (step 802). The process creates a profile for the user based on the spending patterns using the machine learning model (step 804). The process terminates thereafter.

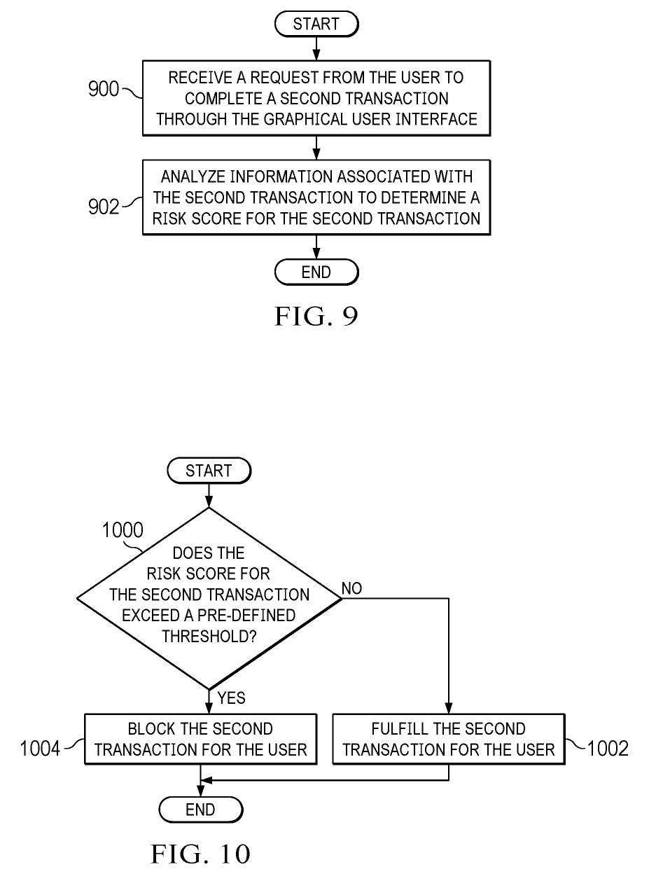

Turning next to FIG. 9, a flowchart of a process for determining a risk score for a transaction is depicted in accordance with an illustrative embodiment. The process in this figure is an example of an additional step that can be performed with the steps in FIG. 8.

The process begins by receiving a request from the user to complete a second transaction through the graphical user interface (step 900). The process analyzes information associated with the second transaction to determine a risk score for the second transaction (step 902). The process terminates thereafter.

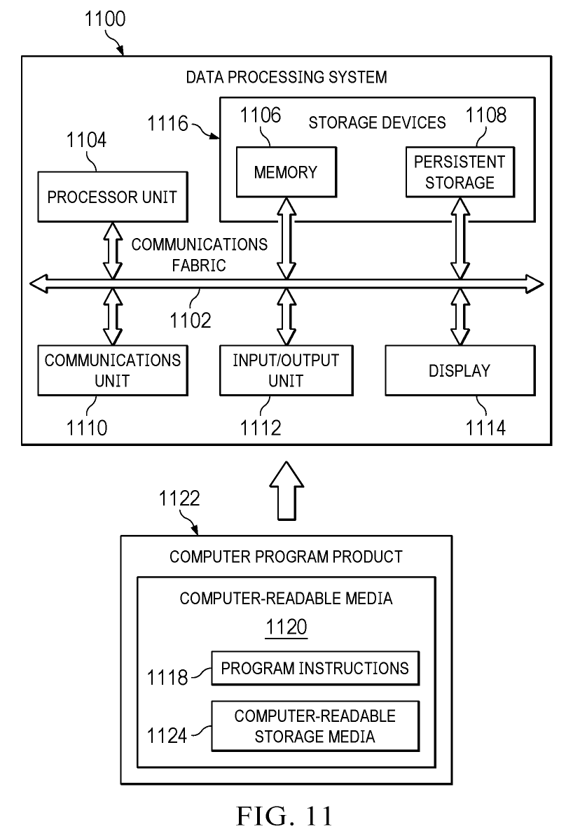

Turning next to FIG. 10, a flowchart of a process for blocking transactions is depicted in accordance with an illustrative embodiment. The process in this figure is an example of an additional step that can be performed with the steps in FIG. 9.

The process begins by determining whether the risk score for the second transaction exceeds a pre-defined threshold (step 1000). If the risk score for the second transaction does not exceed the pre-defined threshold, the process fulfills the second transaction for the user (step 1002). The process terminates thereafter.

With reference again to step 1000, if the risk score for the second transaction exceeds the pre-defined threshold, the process blocks the second transaction for the user (step 1004). The process terminates thereafter.

Turning now to FIG. 11, a block diagram of a data processing system is depicted in accordance with an illustrative embodiment. Data processing system 1100 can be used to implement computers and computing devices in computing environment 100 in FIG. 1. Data processing system 1100 can also be used to implement computer system 204 in FIG. 2. In this illustrative example, data processing system 1100 includes communications framework 1102, which provides communications between processor unit 1104, memory 1106, persistent storage 1108, communications unit 1110, input/output (I/O) unit 1112, and display 1114. In this example, communications framework 1102 takes the form of a bus system.

Processor unit 1104 serves to execute instructions for software that can be loaded into memory 1106. Processor unit 1104 includes one or more processors. For example, processor unit 1104 can be selected from at least one of a multicore processor, a central processing unit (CPU), a graphics processing unit (GPU), a physics processing unit (PPU), a digital signal processor (DSP), a network processor, or some other suitable type of processor. Further, processor unit 1104 can be implemented using one or more heterogeneous processor systems in which a main processor is present with secondary processors on a single chip. As another illustrative example, processor unit 1104 can be a symmetric multi-processor system containing multiple processors of the same type on a single chip.

Memory 1106 and persistent storage 1108 are examples of storage devices 1116. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 1116 may also be referred to as computer-readable storage devices in these illustrative examples. Memory 1106, in these examples, can be, for example, a random-access memory or any other suitable volatile or non-volatile storage device. Persistent storage 1108 may take various forms, depending on the particular implementation.

For example, persistent storage 1108 may contain one or more components or devices. For example, persistent storage 1108 can be a hard drive, a solid-state drive (SSD), a flash memory, a rewritable optical disk, a rewritable magnetic tape, or some combination of the above. The media used by persistent storage 1108 also can be removable. For example, a removable hard drive can be used for persistent storage 1108.

Communications unit 1110, in these illustrative examples, provides for communications with other data processing systems or devices. In these illustrative examples, communications unit 1110 is a network interface card.

Input/output unit 1112 allows for input and output of data with other devices that can be connected to data processing system 1100. For example, input/output unit 1112 may provide a connection for user input through at least one of a keyboard, a mouse, or some other suitable input device. Further, input/output unit 1112 may send output to a printer. Display 1114 provides a mechanism to display information to a user.

Instructions for at least one of the operating system, applications, or programs can be located in storage devices 1116, which are in communication with processor unit 1104 through communications framework 1102. The processes of the different embodiments can be performed by processor unit 1104 using computer-implemented instructions, which may be located in a memory, such as memory 1106.

These instructions are referred to as program instructions, computer usable program instructions, or computer-readable program instructions that can be read and executed by a processor in processor unit 1104. The program instructions in the different embodiments can be embodied on different physical or computer-readable storage media, such as memory 1106 or persistent storage 1108.

Program instructions 1118 are located in a functional form on computer-readable media 1120 that is selectively removable and can be loaded onto or transferred to data processing system 1100 for execution by processor unit 1104. Program instructions 1118 and computer-readable media 1120 form computer program product 1122 in these illustrative examples. In the illustrative example, computer-readable media 1120 is computer-readable storage media 1124.

Computer-readable storage media 1124 is a physical or tangible storage device used to store program instructions 1118 rather than a medium that propagates or transmits program instructions 1118. Computer-readable storage media 1124, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program instructions 1118 can be transferred to data processing system 1100 using a computer-readable signal media. The computer-readable signal media are signals and can be, for example, a propagated data signal containing program instructions 1118. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 1120” can be singular or plural. For example, program instructions 1118 can be located in computer-readable media 1120 in the form of a single storage device or system. In another example, program instructions 1118 can be located in computer-readable media 1120 that is distributed in multiple data processing systems. In other words, some instructions in program instructions 1118 can be located in one data processing system while other instructions in program instructions 1118 can be located in one data processing system. For example, a portion of program instructions 1118 can be located in computer-readable media 1120 in a server computer while another portion of program instructions 1118 can be located in computer-readable media 1120 located in a set of client computers.

The different components illustrated for data processing system 1100 are not meant to provide architectural limitations to the manner in which different embodiments can be implemented. In some illustrative examples, one or more of the components may be incorporated in or otherwise form a portion of another component. For example, memory 1106, or portions thereof, may be incorporated in processor unit 1104 in some illustrative examples. The different illustrative embodiments can be implemented in a data processing system including components in addition to or in place of those illustrated for data processing system 1100. Other components shown in FIG. 11 can be varied from the illustrative examples shown. The different embodiments can be implemented using any hardware device or system capable of running program instructions 1118.

Thus, illustrative embodiments of the present disclosure provide a computer-implemented method, computer system, and computer program product for managing containers. The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes,” “including,” “has,” “contains,” and variants thereof are used herein, such terms are intended to be inclusive in a manner similar to the term “comprises” as an open transition word without precluding any additional or other elements.

The descriptions of the various embodiments of the present invention have been presented for purposes of illustration but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A computer implemented method comprising:
receiving, by a processor set, a request from a user to complete a transaction to purchase a number of items through a graphical user interface;
generating, by the processor set, a number of visual representations for the number of items on the graphical user interface, wherein the number of visual representations represent monetary values for the number of items; and
generating, by the processor set, a number of obstacles associated with the number of visual representations on the graphical user interface for the user to complete the transaction, wherein the number of obstacles associated with the number of visual representations on the graphical user interface causes delay for the transaction to complete.

2. The computer implemented method of claim 1, further comprising:
receiving, by the processor set, a number of user inputs from the user to resolve the number of obstacles; and
completing, by the processor set, the transaction to purchase the number of items for the user.

3. The computer implemented method of claim 1, further comprising:
storing, by the processor set, the number of items, the monetary values associated with the number of items, duration for completing the transaction, the number of visual representations for the number of items, and the number of obstacles associated with the number of visual representations as part of historical data associated with historical transactions.

4. The computer implemented method of claim 3, further comprising:
training, by the processor set, a machine learning model using the historical data associated with historical transactions as training dataset, wherein the machine learning model is trained for generating visual representations that minimizes understanding gap;
identifying, by the processor using the machine learning model, spending patterns for the user based on the historical data associated with historical transactions; and
creating, by the processor set using the machine learning model, a profile for the user based on the spending patterns.

5. The computer implemented method of claim 4, further comprising:
receiving, by the processor set, a second request from the user to complete a second transaction through the graphical user interface; and
analyzing, by the processor set, information associated with the second transaction to determine a risk score for the second transaction.

6. The computer implemented method of claim 5, further comprising:
determining, by the processor set, whether the risk score for the second transaction exceeds a pre-defined threshold; and
in response to determining that the risk score for the second transaction exceeds the pre-defined threshold, blocking, by the processor set, the second transaction for the user.

7. The computer implemented method of claim 1, further comprising:
exiting, by the processor set, the transaction without completing the transaction.

8. A computer system comprising:
a processor set;
a set of one or more computer-readable storage media; and
program instructions stored on the set of one or more storage media to cause the processor set to perform operations comprising:
receiving a request from a user to complete a transaction to purchase a number of items through a graphical user interface;
generating a number of visual representations for the number of items on the graphical user interface, wherein the number of visual representations represent monetary values for the number of items; and
generating a number of obstacles associated with the number of visual representations on the graphical user interface for the user to complete the transaction, wherein the number of obstacles associated with the number of visual representations on the graphical user interface causes delay for the transaction to complete.

9. The computer system of claim 8, wherein the operations further comprise:
receiving a number of user inputs from the user to resolve the number of obstacles; and
completing the transaction to purchase the number of items for the user.

10. The computer system of claim 8, wherein the operations further comprise:
storing the number of items, the monetary values associated with the number of items, duration for completing the transaction, the number of visual representations for the number of items, and the number of obstacles associated with the number of visual representations as part of historical data associated with historical transactions.

11. The computer system of claim 10, wherein the operations further comprise:
training a machine learning model using the historical data associated with historical transactions as training dataset, wherein the machine learning model is trained for generating visual representations that minimizes understanding gap;
identifying spending patterns for the user based on the historical data associated with historical transactions using the machine learning model; and
creating a profile for the user based on the spending patterns using the machine learning model.

12. The computer system of claim 11, wherein the operations further comprise:
receiving a second request from the user to complete a second transaction through the graphical user interface; and
analyzing information associated with the second transaction to determine a risk score for the second transaction.

13. The computer system of claim 12, wherein the operations further comprise:
determining whether the risk score for the second transaction exceeds a pre-defined threshold; and
in response to determining that the risk score for the second transaction exceeds the pre-defined threshold, blocking the second transaction for the user.

14. The computer system of claim 8, wherein the operations further comprise:
exiting the transaction without completing the transaction.

15. A computer program product comprising:
a set of one or more computer-readable storage media; and
program instructions stored in the set of one or more computer-readable storage media to perform operations comprising:
receiving, by a processor set, a request from a user to complete a transaction to purchase a number of items through a graphical user interface;
generating, by the processor set, a number of visual representations for the number of items on the graphical user interface, wherein the number of visual representations represent monetary values for the number of items; and
generating, by the processor set, a number of obstacles associated with the number of visual representations on the graphical user interface for the user to complete the transaction, wherein the number of obstacles associated with the number of visual representations on the graphical user interface causes delay for the transaction to complete.

16. The computer program product of claim 15, wherein the operations further comprise:
receiving, by the processor set, a number of user inputs from the user to resolve the number of obstacles; and
completing, by the processor set, the transaction to purchase the number of items for the user.

17. The computer program product of claim 15, wherein the operations further comprise:
storing, by the processor set, the number of items, the monetary values associated with the number of items, duration for completing the transaction, the number of visual representations for the number of items, and the number of obstacles associated with the number of visual representations as part of historical data associated with historical transactions.

18. The computer program product of claim 17, wherein the operations further comprise:
training, by the processor set, a machine learning model using the historical data associated with historical transactions as training dataset, wherein the machine learning model is trained for generating visual representations that minimizes understanding gap;
identifying, by the processor using the machine learning model, spending patterns for the user based on the historical data associated with historical transactions; and
creating, by the processor set using the machine learning model, a profile for the user based on the spending patterns.

19. The computer program product of claim 18, wherein the operations further comprise:
receiving, by the processor set, a second request from the user to complete a second transaction through the graphical user interface; and
analyzing, by the processor set, information associated with the second transaction to determine a risk score for the second transaction.

20. The computer program product of claim 19, wherein the operations further comprise:
determining, by the processor set, whether the risk score for the second transaction exceeds a pre-defined threshold; and
in response to determining that the risk score for the second transaction exceeds the pre-defined threshold, blocking, by the processor set, the second transaction for the user.
